(19) United States
(12) Patent Application Publication
(10) Pub. No.: US 2021/0152794 A1
(43) Pub. Date: May 20, 2021

(54) OPTICAL MULTIPLEXER, LIGHT SOURCE MODULE, TWO-DIMENSIONAL OPTICAL SCANNING DEVICE, AND IMAGE PROJECTION DEVICE

(71) Applicant: University of Fukui, Fukui-shi (JP)

(72) Inventors: Shoji Yamada, Fukui-shi (JP); Toshio Katsuyama, Fukui-shi (JP)

(73) Assignee: University of Fukui, Fukui-shi (JP)

(21) Appl. No.: 17/159,661

(22) Filed: Jan. 27, 2021

Related U.S. Application Data
(63) Continuation of application No. PCT/JP2018/041523, filed on Nov. 8, 2018.

(51) Int. Cl. H04N 9/31

(52) U.S. Cl. CPC H04N 9/3155; H04N 9/3164; H04N 9/3161

(57) ABSTRACT

The invention relates to an optical multiplexer, a light source module, a two-dimensional optical scanning device and an image projection device, where the light beam intensity from a plurality of light sources can be attenuated to a desired value without installing an additional optical attenuator element. The optical coupling ratio of an optical coupling part provided in an optical multiplexing unit is set in such a manner that the total intensity of light beams that have been inputted into individual input optical waveguides from the light sources is attenuated by a value in a range from 5 dB to 40 dB at a stage of being outputted as multiplexed light from an output optical waveguide.

### CROSS-REFERENCE TO RELATED APPLICATION

This application is a continuation application of International Application Number PCT/JP2018/041523 filed on Nov. 8, 2018 and designated the U.S., the entire contents of which are incorporated herein by reference.

### FIELD

The present invention relates to an optical multiplexer, a light source module, a two-dimensional optical scanning device and an image projection device, and relates to, for example a configuration for attenuating the intensity of a light beam from a light source to a desired value without installing an additional optical attenuator element.

### BACKGROUND

Various types of light beam multiplexing light source devices have been known as conventional devices for multiplexing a plurality of light beams such as laser beams so as to emit one beam. From among these, light beam multiplexing light source devices where a semiconductor laser and an optical waveguide-type multiplexer are combined are characterized in that the device can be made compact and the power can be reduced, and thus are applied to a laser beam scanning-type color image projection device (see Patent Literature 1 through 6).

Conventional light beam multiplexing light sources where a semiconductor laser and an optical waveguide-type optical multiplexer are combined include a light beam multiplexing light source for multiplexing three primary color laser beams as illustrated in Patent Literature 3, for example.

FIG. 19 is a schematic diagram illustrating the configuration of a conventional optical multiplexer made by the present inventor (see Patent Literature 2). The configuration has input optical waveguides 23 through 25 formed of a core layer and a clad layer, an optical multiplexing unit 40 and an output optical waveguide 27. The input optical waveguide 23 is optically coupled with the input optical waveguide 24 through optical coupling part 41 and 42 in the optical multiplexing unit 40. The input optical waveguide 25 is optically coupled with the input optical waveguide 24 through an optical coupling part 43 in the optical multiplexing unit 40.

A blue semiconductor laser chip 31, a green semiconductor laser chip 32 and a red semiconductor laser chip 33 are installed at the entrance ends of the input optical waveguides 23 through 25 that correspond to the respective colors. Here, light beams propagate through the core layers in the input optical waveguides 23 through 25 so as to be multiplexed in the optical multiplexer 40, and after that, the multiplexed light is emitted from the emission end of the output optical waveguide 27 that is an extended portion of the input optical waveguide 24.

FIG. 20 is a perspective diagram schematically illustrating a two-dimensional light scanning device that has been proposed by the present inventor (see Patent Literature 6). An optical multiplexer 62 is provided on a substrate 61 in which a movable mirror unit 63 is formed, and a blue semiconductor laser chip 31, a green semiconductor laser chip 32 and a red semiconductor laser chip 33 are coupled with the optical multiplexer 62. In the case where the light sources for generating a light beam are integrated with the movable mirror unit 63, the size of the entirety after integration can be made small since the movable mirror unit 63 is compact. In the case where the light beams emitted from the light sources are those from semiconductor laser chips or optical multiplexers, in particular, these semiconductor laser chips or optical multiplexers may be formed on an Si substrate or a metal plate substrate, and therefore, the light sources and the two-dimensional light scanning mirror device can be formed on these substrates in order to gain such effects that the size of the entirety after the integration can be made small.

FIG. 21 is a perspective diagram schematically illustrating the image projection device that has been proposed by the present inventor (see Patent Document 6) as the combination of a two-dimensional scanning device as described above, a two-dimensional scanning control unit for two-dimensional scanning with emission light that is emitted from a light source by applying a two-dimensional light scanning signal to an electromagnetic coil 64, and an image formation unit for projecting onto a projection surface an image that is scanned with the emission light. Here, a typical example of the image projection device is an eyeglass-type retina scanning display.

Efforts have been made to develop the conventional light beam multiplexing light source devices of this type in order to maximize the efficiency in the transmission from the semiconductor laser output to the light source device output. It is possible to make the efficiency in the transmission 90% or greater by improving the efficiency in the coupling between the semiconductor lasers and the optical waveguides of the optical multiplexer and the efficiency in the optical multiplexing. In this case, conventional semiconductor lasers can be operated with the rated output so as to make the multiplexer output several mW.

### CITATION LIST

### Patent Literature

Patent Literature 1: Japanese Unexamined Patent Publication 2008-242207
Patent Literature 2: Japanese Unexamined Patent Publication 2013-195603
Patent Literature 3: International Unexamined Patent Publication 2015/170505
Patent Literature 4: U.S. Unexamined Patent Publication 2010/0073262
Patent Literature 5: International Unexamined Patent Publication 2017/065225
Patent Literature 6: Japanese Unexamined Patent Publication 2018-072591

### Non-Patent Literature

Non-Patent Literature 1: IEEE Photonics Technology Letters, Vol. 19, No. 5, pp. 330-332, Mar. 1, 2007.

In a retina scanning-type display to which a multiplexing light source device is mainly applied, the optical power for the final entrance into a pupil of a viewer is approximately 10 μW. In the case where the semiconductor lasers are driven with a small current in order to make the optical power for the entrance into a pupil smaller, such a problem arises that the optical dynamic range shrinks due to a spontaneous light component emission. Meanwhile, in the case where the minimum level drive current is made greatly smaller than a threshold value current in order to suppress the spontaneous light component emission, such a problem arises that the rapid optical modulation becomes difficult. That is to say, the drive current for a semiconductor laser changes in accordance with the brightness for each pixel of the displayed image, and thus, it is desirable for the range of the change of the drive current to be at the threshold current value or greater in order to secure the rapid modulation. In this case, however, residual light exists due to spontaneous light emission even when the drive current is made the minimum value (threshold current value) in order to display the lowest brightness (black level), and thus, the contrast is determined as the ratio of this residual light to the light quantity at the time when the drive current is maximum (white level). In the case where the maximum value of the drive current is sufficiently great, the white level light quantity is large, and therefore, the necessary contrast can be sufficiently secured. However, it is necessary to set the maximum value of the drive current low since the optical power that is required for the retina scanning-type display is small. When the maximum value of the drive current is set low, the white level light quantity becomes small, whereas the black level residual light quantity does not vary with the minimum value of the drive current remaining at the threshold value, which therefore lowers the contrast. In order to increase the contrast in the case where the maximum value of the drive current is set low, it is necessary for the drive current for the pixels that is close to the black level to be set to the threshold value or lower in order to make the light quantity of spontaneous emission low. In this case as well, the semiconductor lasers are driven with a current that is equal to or greater than the threshold current for standard pixels, and the drive current is switched to the one that is equal to or lower than the threshold current timewise only when a pixel that is close to the black level is displayed. The ratio depends on the contents of the image.

As another method for lowering the optical power, there is a technique for inserting an optical attenuator element such as a light absorber/reflector or an optical axis shift coupling unit into the optical path. In this case, an additional element for causing light attenuation is necessary, and moreover, there is a concern that the reliability may be lowered due to the change in the characteristics of the additional optical element or the displacement in the alignment.

An object of the present invention is to provide an optical multiplexer having an input optical waveguide, an output optical waveguide and an optical multiplexing unit where the intensity of a light beam from a light source can be attenuated to a desired value without installing an additional optical attenuator

### SUMMARY

According to one embodiment, the optical multiplexer is provided with a plurality of input optical waveguides that include at least a first input optical waveguide and a second input optical waveguide, and an output optical waveguide having an optical multiplexing unit where at least a portion thereof is an optical waveguide in linear form. The first input optical waveguide has a first optical coupling part for optical coupling with the output optical waveguide in the optical multiplexing unit. The second input optical waveguide has a second optical coupling part for optical coupling with the output optical waveguide in the optical multiplexing unit. The first optical coupling part is set so that the attenuation of the light beam that has been inputted into the first input optical waveguide relative to the light beam that is outputted from the output optical waveguide is in a range from 5 dB to 40 dB. The second optical coupling part is set so that the attenuation of the light beam that has been inputted into the second input optical waveguide relative to the light beam that is outputted from the output optical waveguide is in a range from 5 dB to 40 dB.

According to another embodiment, the light source module has an optical multiplexer as described above and a plurality of light sources for emitting light beams into the optical multiplexer.

According to still another embodiment, a two-dimensional light scanning device has a light source module as described above and a two-dimensional light scanning mirror device for two-dimensional scanning with multiplexed light from the light source module.

According to yet another embodiment, an image projection device has a two-dimensional light scanning device as described above and an image formation unit for projecting onto a projection surface an image scanned with multiplexed light by means of a two-dimensional light scanning mirror device as described above.

In accordance with one aspect of an optical multiplexer having an input optical waveguide, an output optical waveguide and an optical multiplexing unit, it becomes possible for the intensity of a light beam from a light source to be attenuated to a desired value without installing an additional optical attenuator element. A compact retina scanning-type display with high reliability can be gained by using such an optical multiplexer.

### BRIEF DESCRIPTION OF DRAWINGS

FIG. 1 is a plan diagram schematically illustrating an optical multiplexer according to one embodiment of the present invention;

FIGS. 2A and 2B are schematic diagrams illustrating the configuration of the optical multiplexer in Example 1 of the present invention;

FIGS. 3A and 3B are diagrams illustrating the state of propagation of a red beam in the optical multiplexer in Example 1 of the present invention;

FIGS. 4A and 4B are diagrams illustrating the state of propagation of a green beam in the optical multiplexer in Example 1 of the present invention;

FIGS. 5A and 5B are diagrams illustrating the state of propagation of a blue beam in the optical multiplexer in Example 1 of the present invention;

FIG. 6 is a plan diagram schematically illustrating the optical multiplexer in Example 2 of the present invention;

FIGS. 7A and 7B are diagrams illustrating the state of propagation of a red beam in the optical multiplexer in Example 2 of the present invention;

FIGS. 8A and 8B are diagrams illustrating the state of propagation of a green beam in the optical multiplexer in Example 2 of the present invention;

FIGS. 9A and 9B are diagrams illustrating the state of propagation of a blue beam in the optical multiplexer in Example 2 of the present invention;

FIG. 10 is a plan diagram schematically illustrating the optical multiplexer in Example 3 of the present invention;

FIG. 11 is a plan diagram schematically illustrating the optical multiplexer in Example 4 of the present invention;

FIG. 12 is a plan diagram schematically illustrating the optical multiplexer in Example 5 of the present invention;

FIG. 13 is a plan diagram schematically illustrating the optical multiplexer in Example 6 of the present invention;

FIG. 14 is a plan diagram schematically illustrating the optical multiplexer in Example 7 of the present invention;

FIG. 15 is a diagram schematically illustrating the light source module in Example 8 of the present invention;

FIG. 16 is a diagram schematically illustrating the light source module in Example 9 of the present invention;

FIG. 17 is a diagram schematically illustrating the light source module in Example 10 of the present invention;

FIG. 18 is a diagram schematically illustrating the light source module in Example 11 of the present invention;

FIG. 19 is a plan diagram schematically illustrating a conventional optical multiplexer provided by the present inventor;

FIG. 20 is a perspective diagram schematically illustrating an example of a conventional two-dimensional light scanning device; and

FIG. 21 is a perspective diagram schematically illustrating a conventional image formation device.

### DESCRIPTION OF EMBODIMENTS

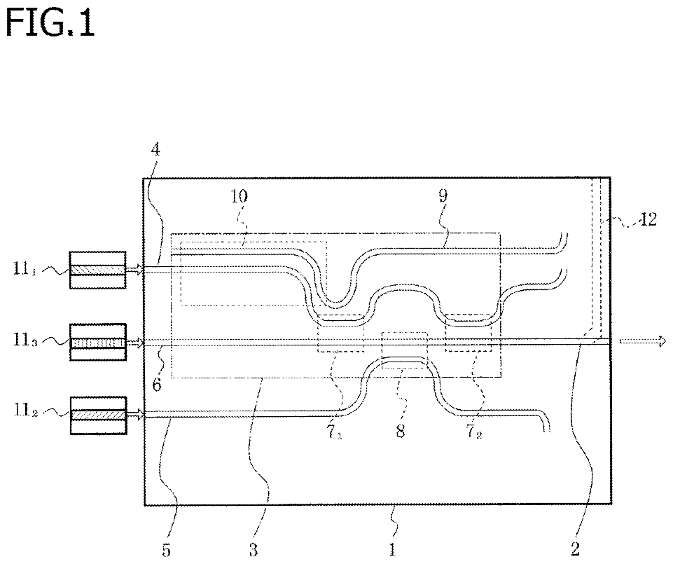

An example of the optical multiplexer according to an embodiment of the present invention is described in reference to FIG. 1. FIG. 1 is a plan diagram schematically illustrating the optical multiplexer according to the embodiment of the present invention. Here, the optical multiplexer is described as a light source module by adding light sources 11₁ through 11₃. As illustrated in FIG. 1, the optical multiplexer according to the embodiment of the present invention is provided with a plurality of input optical waveguides 4 through 6 that includes at least a first input optical waveguide 4 and second input optical waveguide 5, and an output optical waveguide 2 having an optical multiplexing unit 3 where at least a portion thereof is an optical waveguide in linear form. The first input optical waveguide 4 has first optical coupling parts 7₁ and 7₂ for optical coupling with the output optical waveguide 2 in the optical multiplexing unit 3. The second input optical waveguide 5 has a second optical coupling part 8 for optical coupling with the output optical waveguide 2 in the optical multiplexing unit 3. Here, the light sources 11₁ through 11₃ are typically semiconductor lasers; however, the light sources may be light-emitting diodes (LEDs) or may have optical fibers in-between.

The first optical coupling part 7₁ and 7₂ are set so that the total attenuation of the light beam that has been inputted into the first input optical waveguide 4 relative to the light beam that is outputted from the output optical waveguide 2 is in a range from 5 dB to 40 dB. The second optical coupling part 8 is set so that the attenuation of the light beam that has been inputted into the second input optical waveguide 5 relative to the light beam that is outputted from the output optical waveguide 2 is in a range from 5 dB to 40 dB.

That is to say, depending on the rated output P_{Id} of a semiconductor laser (=1 mW to 10 mW), the coupling loss a_{cp} with the optical waveguide and the transmission loss a_{sys} in the display optical system, the light attenuation aₘₚₓ of the entrance power that has been entered into the input optical waveguides 4 through 6 relative to the optically multiplexed output power that is outputted from the output optical waveguide 2 (=10 log (P_{Id}/P_{dp})−a_{cp}−a_{sys}) is required to have a value range from 5 dB to 40 dB, more preferably, a value range from 10 dB to 30 dB. Here, P_{dp} is a so-called display optical power and is approximately 1 μW to 10 μW. In addition, the loss (a_{cp}+a_{sys}) becomes 15 dB or less. Even in the case where P_{Id} is the minimum of 1 mW and the loss (a_{cp}+a_{sys}) is the maximum of 15 dB, the attenuation that is lower than 5 dB makes the display optical power have a value that exceeds a required range P_{dp}. Meanwhile, the attenuation that exceeds 40 dB makes it impossible to gain the required light quantity. Here, the end of each optical waveguide in the optical multiplexing unit 3 is arranged in such a manner that the emission light is not mixed with the multiplexed light, and actually extends to an end of the substrate 1 (the same is applied in the figures illustrating the respective embodiments below). Here, the number of input optical waveguides is any and may be two, four or more. In the case of four or more, yellow or infrared rays may be added in addition to the three primary colors. The attenuation rate is set in accordance with the length the directional coupler that forms each optical coupling part (7₁, 7₂, 8 and 10) and the intervals at which the optical waveguides that form the directional couplers are located.

The output optical waveguide 2 is an optical waveguide in linear form in at least the area other than the proximity to the emission end, and may be inclined in proximity to the emission end at an angle of 85° to 95° relative to the optical waveguide (2) in linear form as the bending portion 12 represented by a broken line in the figure. Stray light that has leaked out from the optical coupling part 7₁, 7₂ or 8 in the optical multiplexing unit 3 can certainly be prevented from overlapping the multiplexed light by providing the bending portion 12 as described above.

A third input optical waveguide 6 may be provided as one of the plurality of input optical waveguides so that the third input optical waveguide 6 can also be used as the optical waveguide on the entrance end side of the output optical waveguide 2. The first input optical waveguide 4 is provided with a third optical coupling part 10 for wave dividing the light beam that has entered into the first input optical waveguide 4 in the stage before the optical coupling with the optical multiplexing unit 3. In order to do so, an optical waveguide 9 for discarding light that optically couples with the first input optical waveguide 4 is provided. In this case, the first optical coupling part may be separated into two optical coupling parts 7₁ and 7₂ with the second optical coupling part 8 in between.

The plurality of input optical waveguides may include a third input optical waveguide 6 in such a manner that the third input optical waveguide 6 is provided with a third optical coupling part for optical coupling with the second input optical waveguide 5 in the stage before the second optical coupling part 5. Alternatively, the plurality of input optical waveguides may have a third input optical waveguide 6 in such a manner that the third input optical waveguide 6 is provided with a third optical coupling part for optical coupling with the output optical waveguide 2 in the optical multiplexing unit 3.

Here, the optical multiplexing unit 3 is typically an optical multiplexing unit for multiplexing at least the light of three primary colors, that is to say, red light, blue light and green light. In this case, the order of optical coupling with the optical waveguide 2 is any, and for example, the light source 11₁ may emit blue, red or green.

Alternatively, the direction in which waves are guided in proximity to the input ends of the plurality of input optical waveguides 4 through 6 may be inclined at an angle of 85° to 95° relative to the optical waveguide (2) in linear form. The arrangement in this manner can make the size of the optical multiplexer in the direction of the length smaller, and at the same time can reduce the effects of stray light from the light sources. Here, the output end of the output optical waveguide 2 may be inclined by 90° relative to the optical axis of the optical waveguide (2) in linear form in the optical multiplexing unit 3; however, the angle of inclination is in a range from 85° to 95° taking an error in manufacturing into consideration.

The plurality of light sources 11₁ through 11₃ may be arranged along one side of the substrate 1 in such a manner that the direction in which waves are guided in proximity to the input ends of the plurality of input optical waveguides 4 through 6 forms an angle of 85° to 95° with the optical axis of the optical waveguide (2) in linear form in the optical multiplexing unit 3. Alternatively, at least one light source (11₁) from among the plurality of light sources 11₁ through 11₃ may be arranged along a first side of the substrate 1, and the remaining light sources (11₂ and 11₃) may be arranged along a second side that faces the first side in such a manner that the direction in which waves are guided in proximity to the input ends of the plurality of input optical waveguides 4 through 6 forms an angle of 85° to 95° with the optical axis of the optical waveguide (2) in linear form in the optical multiplexing unit 3.

As for the substrate 1, any substrate from among an Si substrate, a glass substrate, a metal substrate, a plastic substrate and the like may be used. As for the material for the lower clad layer, the core layer and the upper clad layer, an SiO₂ glass-based material can be used and a material other than that, for example, a transparent plastic such as an acrylic resin or another transparent material, may be used.

In order to form a light source module, as illustrated in FIG. 1, any of various types of optical multiplexers as described above and a plurality of light sources 11₁ through 11₃ for emitting light beams into the optical multiplexer may be combined. In this case, the light sources 11₁ through 11₃ are typically semiconductor lasers; however, light-emitting diodes may be used. In addition, lenses may be provided between the plurality of light sources 11₁ through 11₃ and the plurality of input optical waveguides 4 through 6 in the optical multiplexer. Furthermore, the emission end of an optical fiber may be installed in the location of each light source in place of the light sources 11₁ through 11₃ in such a manner that the light source device allows the light emitted from the optical fibers to be guided into the optical multiplexing unit 3.

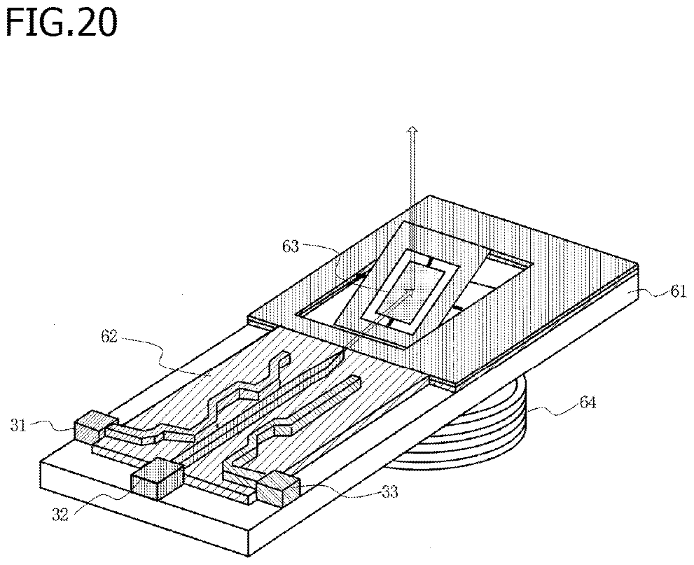

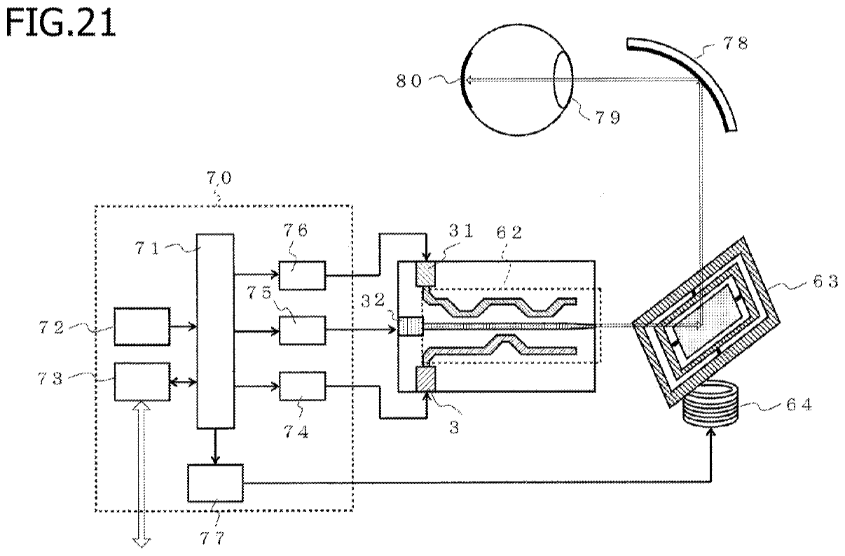

In order to form a two-dimensional optical scanning device, the optical multiplexer 62 in a two-dimensional optical scanning device as illustrated in FIG. 20 may be combined with any of various types of optical multiplexers as described above. In order to form an image projection device, as illustrated in FIG. 21, a two-dimensional scanning device as described above, a two-dimensional scanning control unit for two-dimensional scanning with the emission light emitted from the light source by applying a two-dimensional optical scanning signal to the electromagnetic coil 64, and an image formation unit for projecting an image onto a projection plane with the scanned emission light may be combined. The image projection device is typically an eyeglass-type retina scanning display (see Patent Literature 2). The image projection device according to the embodiment of the present invention is worn on the head of a user by using an eyeglass-type fitting tool, for example (see Patent Literature 4).

As for the structure of each optical waveguide, the respective core layers may be covered with a shared upper clad layer, or the respective core layers may be covered with individual upper clad layers. Alternatively, the structure may be such that the respective core layers are covered with individual lower clad layers and individual upper clad layers.

### Example 1

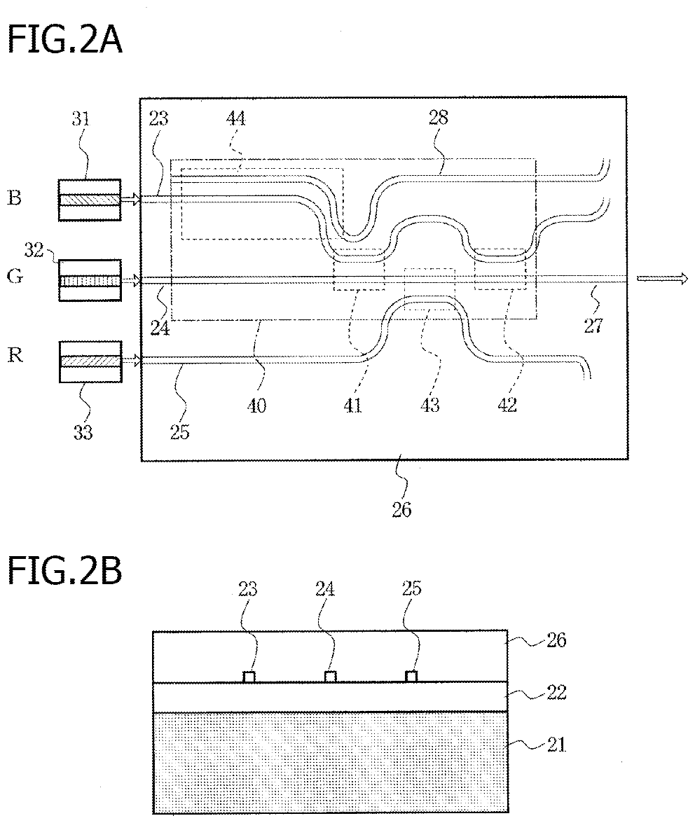

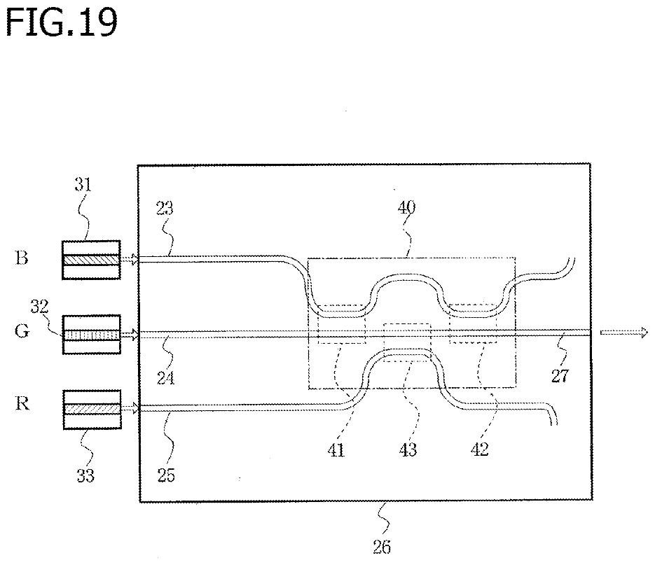

Here, the optical multiplexer in Example 1 of the present invention is described in reference to FIGS. 2A through 5B. FIGS. 2A and 2B are schematic diagrams illustrating the configuration of the optical multiplexer in Example 1 of the present invention. FIG. 2A is a schematic plan diagram, and FIG. 2B is a cross-sectional diagram on the input end side. Here, the optical multiplexer in Example 1 of the present invention is gained by providing the conventional optical multiplexer in FIG. 19 with an optical waveguide for discarded light, and herein is illustrated as a light source module with light sources being added in order to make it easy to understand the invention. As illustrated in FIG. 2A, a light beam from the blue semiconductor laser chip 31 is inputted into the input optical waveguide 23, a light beam from the green semiconductor laser chip 32 is inputted into the input optical waveguide 24, and a light beam from the red semiconductor laser chip 33 is inputted into the input optical waveguide 25. The input optical waveguides 23 through 25 are connected to the optical waveguides in the optical multiplexing unit 40, and the multiplexed light that has been multiplexed in the optical multiplexing unit 40 is outputted from the output end of the output optical waveguide 27. Here, the output end of the output optical waveguide 27 may be a plane such as a mere plane of cleavage, and the shape of the beam may be controlled by using a spot size converter or the like.

As illustrated in FIG. 2B, in each optical waveguide, an SiO₂ layer 22 having a thickness of 20 μm is provided as a lower clad layer on top of an Si substrate 21 having a thickness of 1 mm with a (100) surface, a core layer having a width of 2 μm and a thickness of 2 μm is formed by etching Ge-doped SiO₂ glass that has been provided on top of the SiO₂ layer 22, and an upper clad layer 26 (the thickness on top of the SiO₂ layer 22 becomes 11 μm) made of an SiO₂ layer having a thickness of 9 μm is provided on top of the core layer, and thus, the respective optical waveguides in the input optical waveguides 23 through 25, the optical waveguide 28 for discarding light and the optical multiplexing unit 40 as well as the output waveguide 27 are formed. In this case, the difference in the refractive index between the core layer and the clad layer becomes 0.5%.

As for the size of the optical multiplexing unit 40, the length is 3 mm and the width is 3.1 mm. The length of the optical coupling part 41 is 350 μm, the length of the optical coupling part 42 is 240 μm, the length of the optical coupling part 43 is 200 μm, and the length of the optical coupling part 44 is 1200 μm. The wavelength of light emitted from the blue semiconductor laser chip 31 is 450 nm, the wavelength of light emitted from the green semiconductor laser chip 32 is 520 nm, and the wavelength of light emitted from the red semiconductor laser chip 33 is 638 nm.

The emission areas of the blue semiconductor laser chip 31, the green semiconductor laser chip 32 and the red semiconductor laser chip 33 are adjusted relative to the entrance area of the respective input optical waveguides 23 through 25 in the lateral direction and in the height direction, and thus are mounted with the gap vis-à-vis the entrance end of the input optical waveguides 23 through 25 being 10 μm.

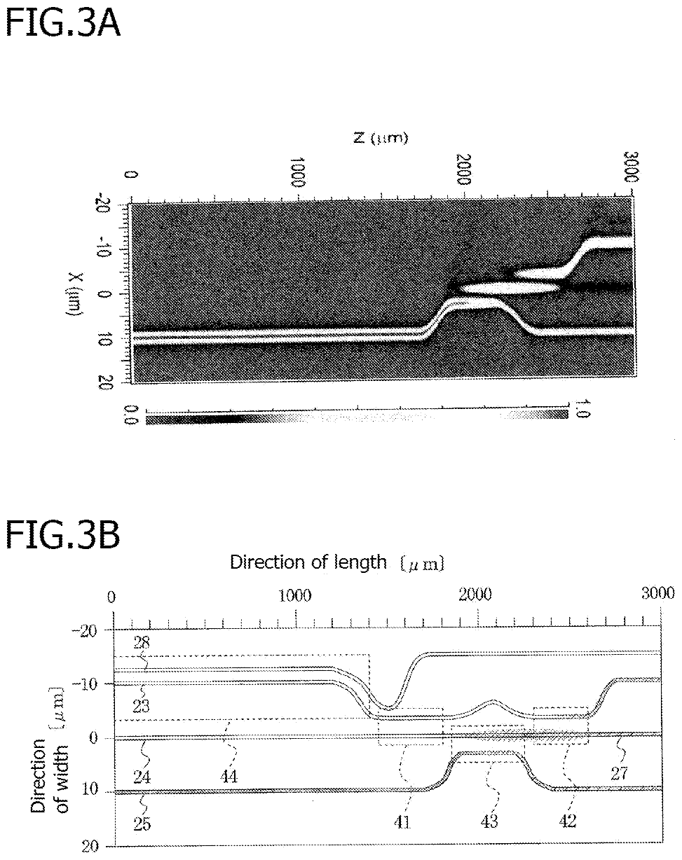

FIGS. 3A and 3B are diagrams illustrating the state of propagation of a red beam in the optical multiplexer in Example 1 of the present invention. FIG. 3A is a diagram illustrating the results of simulation in a graph form, and FIG. 3B is an illustrative diagram illustrating the same as FIG. 3A. 73% of the entrance power of the red beam that has entered into the input optical waveguide 25 is shifted to the output optical waveguide 27 in the optical coupling part 43, and immediately after that, a majority of the power is shifted to the latter-half portion of the input optical waveguide 23 in the optical coupling part 42, and thus, the final output from the output optical waveguide 27 becomes 3.5% of the entrance power (the light attenuation is 14.6 dB).

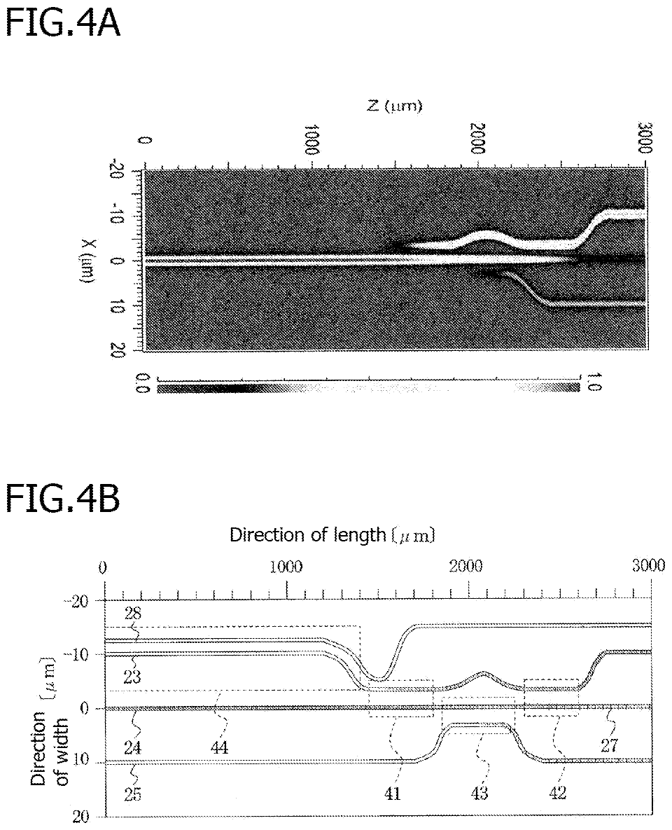

FIGS. 4A and 4B are diagrams illustrating the state of propagation of a green beam in the optical multiplexer in Example 1 of the present invention. FIG. 4A is a diagram illustrating the results of simulation in a graph form, and FIG. 4B is an illustrative diagram illustrating the same as FIG. 4A. A majority of the entrance power of the green beam that has entered into the input optical waveguide 24 is shifted to the latter-half portion of the input optical waveguide 23 in the optical coupling parts 41 and 42, and thus, the final output from the output optical waveguide 27 becomes 5.1% of the entrance power (the light attenuation is 12.9 dB).

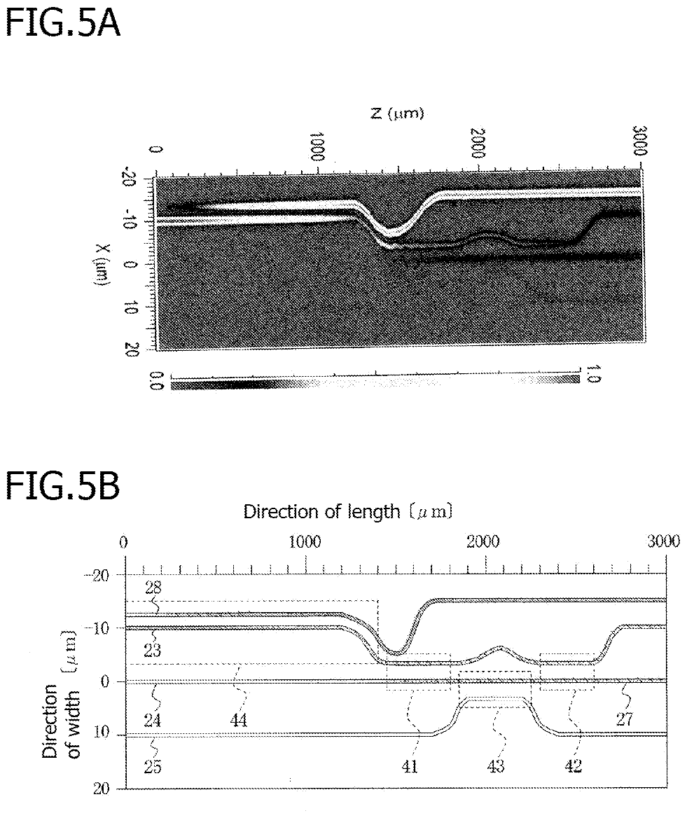

FIGS. 5A and 5B are diagrams illustrating the state of propagation of a blue beam in the optical multiplexer in Example 1 of the present invention. FIG. 5A is a diagram illustrating the results of simulation in a graph form, and FIG. 5B is an illustrative diagram illustrating the same as FIG. 5A. 89% of the entrance power of the blue beam that has entered into the input optical waveguide 23 is shifted to the optical waveguide 28 for discarding light in the optical coupling part 44, and approximately half of the optical power that has remained in the input optical waveguide 23, that is to say, 4.7% of the entrance optical power (the light attenuation is 13.3 dB), is shifted to the output optical waveguide 27 via the optical coupling parts 41 and 42 so as to become the multiplexed light output.

In Example 1 of the present invention, the manufacturing process is established where an optical waveguide 28 for discarding light together with an optical coupling part 44 is provided to a conventional optical multiplexer as illustrated in FIG. 19 of which the characteristics have been confirmed, and at the same time, the already-known coupling coefficient of the optical coupler is simply made approximately half, which makes it possible to independently set the attenuation for the blue beam, and therefore, designing becomes easy. In Example 1 as well, the output optical waveguide 27 may be bent on the emission end side as represented by a broken line in FIG. 1.

### Example 2

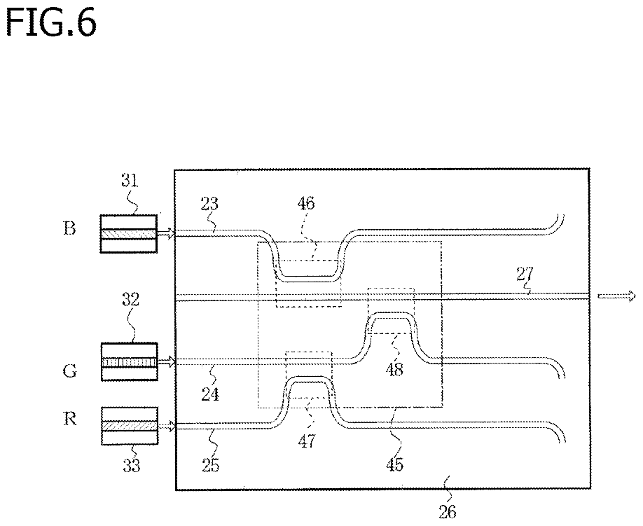

Next, the optical multiplexer in Example 2 of the present invention is described in reference to FIGS. 6 through 9B. FIG. 6 is a plan diagram schematically illustrating the optical multiplexer in Example 2 of the present invention. In order to make it easy to understand the invention, light sources are added so that a light source module is illustrated in the figures. As illustrated in FIG. 6, the optical multiplexing unit 45 forms an optical multiplexer together with input optical waveguides 23 through 25 and an output optical waveguide 27. The configuration does not allow light radiated from the blue semiconductor laser chip 31, the green semiconductor laser chip 32 or the red semiconductor laser chip 33 to be directly coupled with the output optical waveguide 27, and allows the entire output of the multiplexed light to move from the input optical waveguides 23 through 25 via the optical multiplexing unit 45.

The blue semiconductor laser chip 31, the green semiconductor laser chip 32 and the red semiconductor laser chip 33 which function as light sources are arranged so as to be aligned on the input end surface side of the optical multiplexer. The light beams emitted from the blue semiconductor laser chip 31, and the green semiconductor laser chip 32 and the red semiconductor 33 respectively propagate through the optical waveguide 23 through 25 so as to be guided to the optical multiplexing unit 45. Here, the output end of the output optical waveguide 27 may be a plane such as a mere plane of cleavage; however, the shape of the beam may be controlled by using a spot size converter or the like.

In each optical waveguide, an SiO₂ layer 22 having a thickness of 20 μm is provided as a lower clad layer on top of an Si substrate having a thickness of 1 mm with a (100) surface, a core layer having a width of 2 μm and a thickness of 2 μm is formed by etching Ge-doped SiO₂ glass that has been provided on top of the SiO₂ layer, and an upper clad layer made of an SiO₂ layer having a thickness of 9 μm is provided on top of the core layer, and thus, the respective optical waveguides in the input optical waveguides 23 through 25 and the optical multiplexing unit 45 as well as the output waveguide 27 are formed. In this case, the difference in the refractive index between the core layer and the clad layer becomes 0.5%. As for the sides of the optical multiplexing unit 45, the length is 2 mm and the width is 3.1 mm.

The length of the optical coupling part 46 is 100 μm, the length of the optical coupling part 47 is 6 μm, and the length of the optical coupling part 48 is 12 μm. The wavelength of light emitted from the blue semiconductor laser chip 31 is 450 nm, the wavelength of light emitted from the green semiconductor laser chip 32 is 520 nm, and the wavelength of light emitted from the red semiconductor laser chip 33 is 638 nm.

The emission areas of the blue semiconductor laser chip 31, the green semiconductor laser chip 32 and the red semiconductor laser chip 33 are adjusted relative to the entrance area of the respective input optical waveguides 23 through 25 in the lateral direction and in the height direction, and thus are mounted with the gap vis-à-vis the entrance end of the input optical waveguides 23 through 25 being 10 μm.

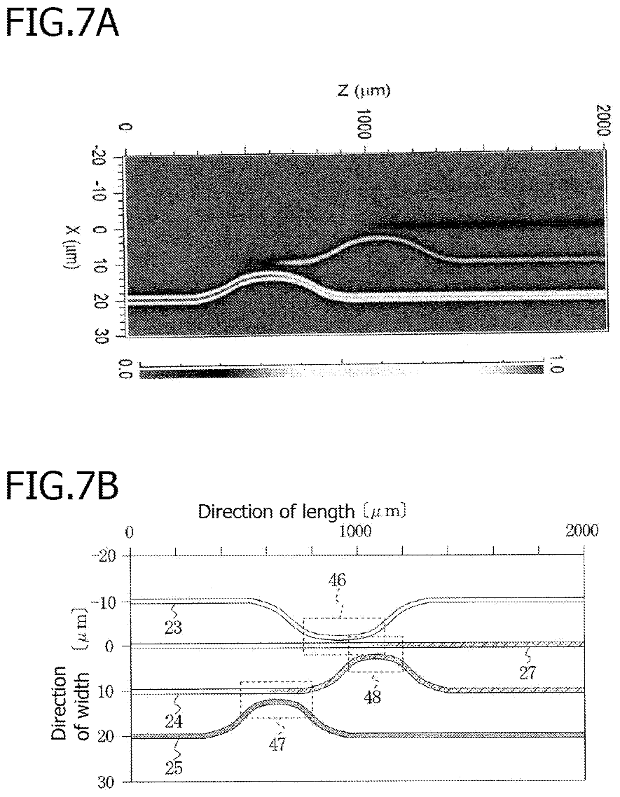

FIGS. 7A and 7B are diagrams illustrating the state of propagation of a red beam in the optical multiplexer in Example 2 of the present invention. FIG. 7A is a diagram illustrating the results of simulation in a graph form, and FIG. 7B is an illustrative diagram illustrating the same as FIG. 7A. 85% of the entrance power of the red beam that has entered into the input optical waveguide 25 propagates as it is through the input optical waveguide 25 after having passed through the optical coupling part 47 of which the coupling coefficient is set to a small value. The red beam that has been shifted to the input optical waveguide 24 is partially shifted to the output optical waveguide 27 in the optical coupling part 48. The output from the optical waveguide 27 becomes 3.2% of the entrance power (the light attenuation is 14.9 dB).

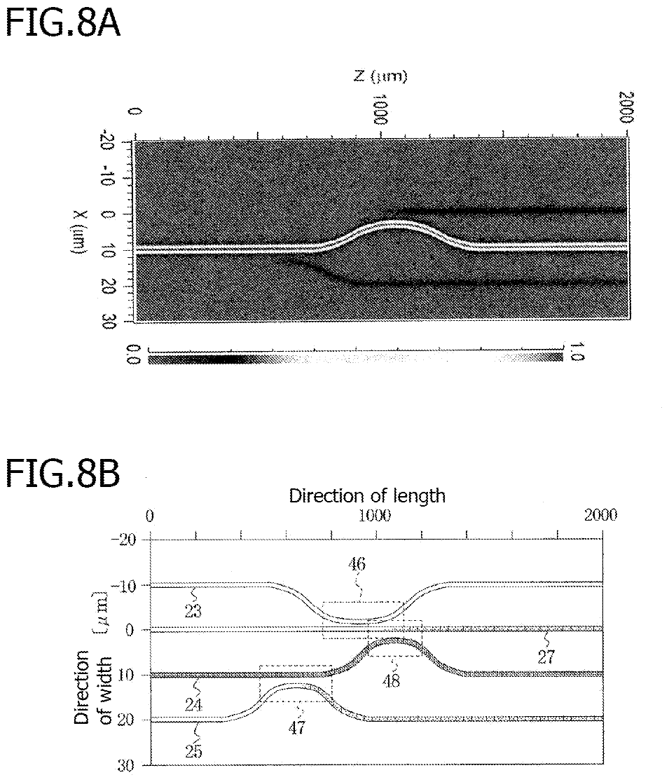

FIGS. 8A and 8B are diagrams illustrating the state of propagation of a green beam in the optical multiplexer in Example 2 of the present invention. FIG. 8A is a diagram illustrating the results of simulation in a graph form, and FIG. 8B is an illustrative diagram illustrating the same as FIG. 8A. 94% of the entrance power of the green beam that has entered into the input optical waveguide 24 propagates as it is through the input optical waveguide 24 after having passed through the optical coupling parts 47 and 48 of which the coupling coefficient is set to a small value. Having been shifted to the output optical waveguide 27 in the optical coupling part 48, the optical power that is emitted from the output optical waveguide 27 is 3.0% of the entrance power (the light attenuation is 15.2 dB).

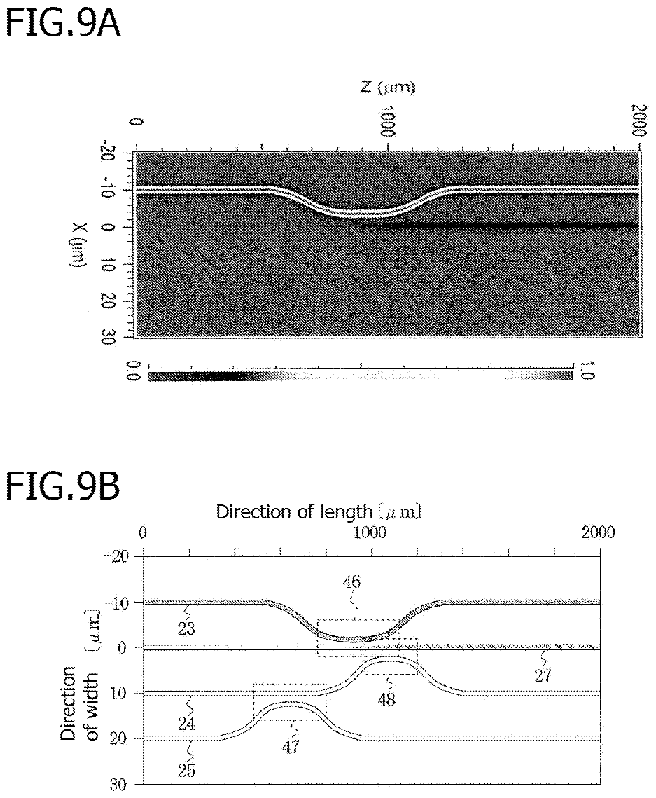

FIGS. 9A and 9B are diagrams illustrating the state of propagation of a blue beam in the optical multiplexer in Example 2 of the present invention. FIG. 9A is a diagram illustrating the results of simulation in a graph form, and FIG. 9B is an illustrative diagram illustrating the same as FIG. 9A. 96% of the entrance power of the blue beam that has entered into the input optical waveguide 23 propagates as it is through the input optical waveguide 23 after having passed through the optical coupling part 46. The blue beam is shifted to the output optical waveguide 27 in the optical coupling part 46 and passes through the optical coupling part 48 before the optical power emitted from the output optical waveguide 27 becomes 2.5% of the entrance power (the light attenuation is 16.0 dB).

In Example 2 of the present invention, the length of the directional coupler that forms each optical coupling part can be made shorter, which makes it possible to make the optical multiplexer compact.

### Example 3

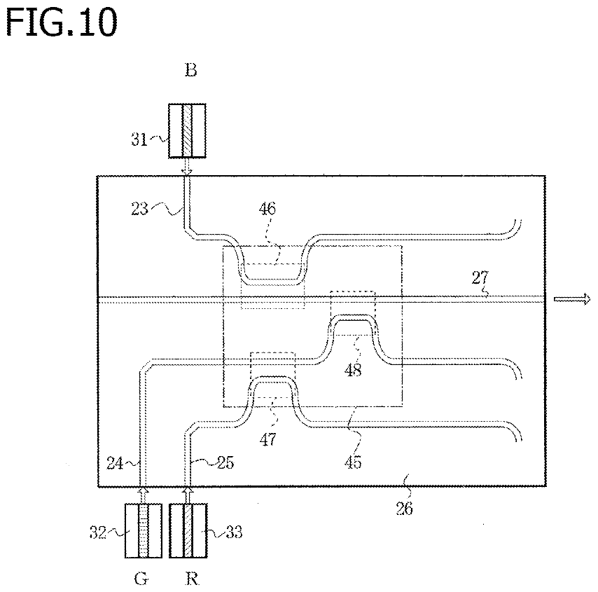

Next, the optical multiplexer in Example 3 of the present invention is described in reference to FIG. 10. The optical multiplexer in Example 3 is gained by altering the above-described optical multiplexer in Example 2 in such a manner that the entrance end side of the input optical waveguides are made perpendicular to the output optical waveguide, and has the basic configuration and the operation principles that are the same as in Example 2.

FIG. 10 is a plan diagram schematically illustrating the optical multiplexer in Example 3 of the present invention. In order to make it easy to understand the invention, light sources are added and a light source module is illustrated in the figure. As illustrated in FIG. 10, the blue semiconductor laser chip 31 is arranged along one long side of an Si substrate, and the green semiconductor laser chip 32 and the red semiconductor laser chip 33 is arranged along the other long side of the Si substrate. Here, the intersection angle between the optical axis of each semiconductor laser and the center axis of the output optical waveguide 27 is 90°. The intersection angle can be any and may be in a range from 85° to 95° taking an error in the manufacturing into consideration. Therefore, the input optical waveguides 23 through 25 are bent in the middle at a right angle in the structure. In order to bend the optical waveguides at a right angle, a trench structure total reflection mirror as illustrated in FIG. 4 in Patent Literature 3 is used; however, a curved waveguide having a small curvature radius may be used.

The light emitted from the semiconductor lasers is not completely coupled with the optical waveguides and partially becomes a light beam in a fan shape that propagates through the clad. By adopting the structure illustrated in FIG. 10, the light beam in a fan shape that propagates through the clad can be prevented from mixing into the multiplexed output light beam path, and therefore, the optical noise can be reduced.

### Example 4

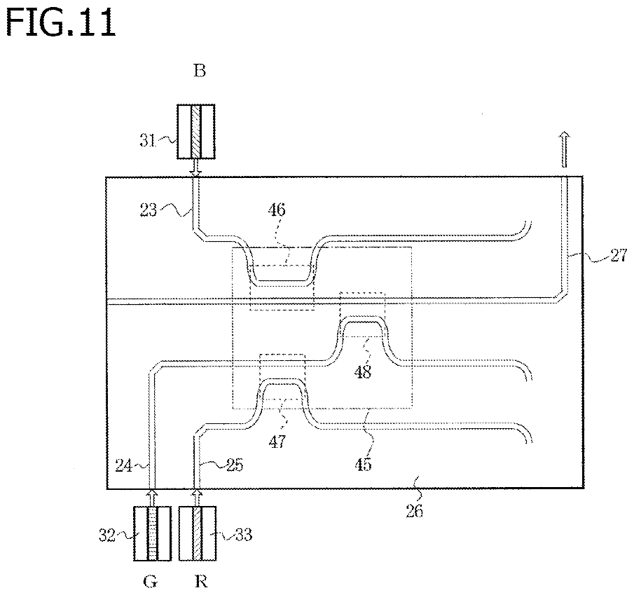

Next, the optical multiplexer in Example 4 of the present invention is described in reference to FIG. 11. The optical multiplexer in Example 4 is gained by bending the above-described output optical waveguides on the emission end side in Example 3, and has the basic configuration and the operation principles that are the same as in Example 3.

FIG. 11 is a plan diagram schematically illustrating the optical multiplexer in Example 4 of the present invention. In order to make it easy to understand the invention, light sources are added hereto as well so that a light source module is illustrated in the figure. As illustrated in FIG. 11, the blue semiconductor laser chip 31 is arranged along one long side of an Si substrate, and the green semiconductor laser chip 32 and the red semiconductor laser chip 33 are arranged along the other long side of the Si substrate. The intersection angle between the optical axis of each semiconductor laser and the center axis of the output optical waveguide 27 in the optical multiplexing unit 45 is 90°. The intersection angle can be any and may be in a range from 85° to 95° taking an error in the manufacturing into consideration. Therefore, the input optical waveguides 23 through 25 are bent in the middle at a right angle in the structure. In order to bend the optical waveguides at a right angle, a trench structure total reflection mirror as illustrated in FIG. 4 in Patent Literature 3 is used; however, a curved waveguide having a small curvature radius may be used.

In Example 4 of the present invention, the output optical waveguide 27 is bent on the emission end side. Here, the bent angle is 90°; however, the bent angle can be any and may be in a range from 85° to 95° taking an error in the manufacturing into consideration. In this case as well, a trench structure total reflection mirror as illustrated in FIG. 4 in Patent Literature 3 is used in order to bend the output optical waveguide 27 at a right angle; however, a curved waveguide having a small curvature radius may be used.

In this case as well, the light beam in a fan shape that propagates through the clad can be prevented from mixing into the multiplexed output light beam path by adopting the structure in FIG. 11 in the same manner as in the structure illustrated in FIG. 10, and therefore, the optical noise can be reduced. Furthermore, light that has leaked out from any of the optical coupling parts 46 through 48 in the optical multiplexing unit 45 does not overlap the multiplexed light emitted from the bent emission end in the output optical waveguide 27, and therefore, the effects of noise light can be further reduced.

### Example 5

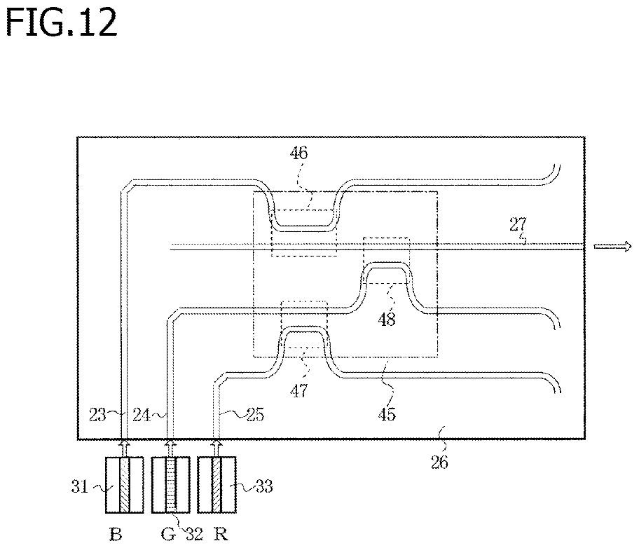

Next, the optical multiplexer in Example 5 of the present invention is described in reference to FIG. 12. The optical multiplexer in Example 5 is the same as the above-described optical multiplexer in Example 3 except that the shape of the input optical waveguide for blue is modified in order to change the arrangement of the light sources. FIG. 12 is a plan diagram schematically illustrating the optical multiplexer in Example 5 of the present invention. Light sources are added hereto as well in order to make it easy to understand the invention so that a light source module is illustrated in the figure.

As illustrated in FIG. 12, a blue semiconductor laser chip 31, a green semiconductor laser chip 32 and a red semiconductor laser chip 33 are arranged along one long side of an Si substrate. The intersection angle between the optical axis of each semiconductor laser and the center axis of the output optical waveguide 27 is 90°. The intersection angle can be any and may be in a range from 85° to 95° taking an error in the manufacturing into consideration. Therefore, the input optical waveguides 23 through 25 are bent in the middle at a right angle in the structure. A trench structure total reflection mirror as illustrated in FIG. 4 in Patent Literature 3 is used in order to bend the optical waveguides at a right angle; however, a curved waveguide having a small curvature radius may be used.

In this case as well, the light beam in a fan shape that propagates through the clad can be prevented from mixing into the multiplexed output light beam path by adopting the structure in FIG. 12 in the same manner as the structure illustrated in FIG. 10, and therefore, optical noise can be reduced. In addition, the light sources are arranged only along one side, and therefore, the sides of a light source module can be made smaller in the direction of the width (longitudinal direction in the figure) in the case where the light source module is formed. In Example 5 as well, the output optical waveguide 27 may be bent on the emission end side in the same manner as in Example 4.

### Example 6

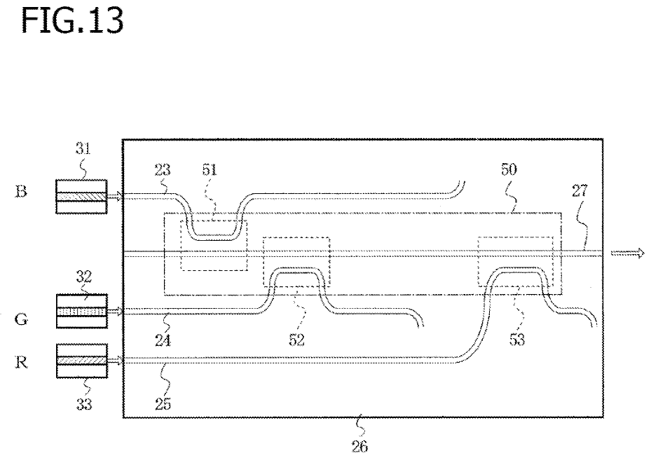

Next, the optical multiplexer in Example 6 of the present invention is described in reference to FIG. 13. FIG. 13 is a plan diagram schematically illustrating the optical multiplexer in Example 6 of the present invention. Light sources are added hereto as well in order to make it easy to understand the invention so that a light source module is illustrated in the figure. An optical multiplexing unit 50 forms an optical multiplexer together with input optical waveguides 23 through 25 and an output optical waveguide 27. The configuration does not allow light radiated from the blue semiconductor laser chip 31, the green semiconductor laser chip 32 and the red semiconductor laser chip 33 to be directly coupled with the output optical waveguide 27, and allows the entire output of the multiplexed light to be shifted from the input optical waveguides 23 through 25 via the optical coupling part 51 through 53.

The coupling coefficients of the optical coupling parts 51 through 53 are respectively set to be 3% for blue, green and red light. The blue light that has been shifted to the output optical waveguide 27 in the optical coupling part 51 passes through two optical coupling parts 52 and 53 before being emitted, and the coupling coefficient for the blue light is smaller than 3%. Accordingly, the quantity of blue light that is shifted to the input optical waveguides 24 and 25 from the output optical waveguide 27 is 0.2% or less of the optical quantity that has entered from the semiconductor laser. Likewise, the quantity of green light that has been shifted to the output optical waveguide 27 in the optical coupling part 52 and is shifted from the output optical waveguide 27 to the input optical waveguide 25 in the optical coupling part 53 is 0.1% or less. The transmission rates of the optical multiplexer for blue, green and red light are all 3% (the light attenuation is 15.2 dB).

In Example 6 of the present invention as well, the light beam intensity can be attenuated to a desired value without installing an additional optical attenuator element by setting the light attenuation coefficient of the optical coupling part so that a desired display optical power can be gained.

### Example 7

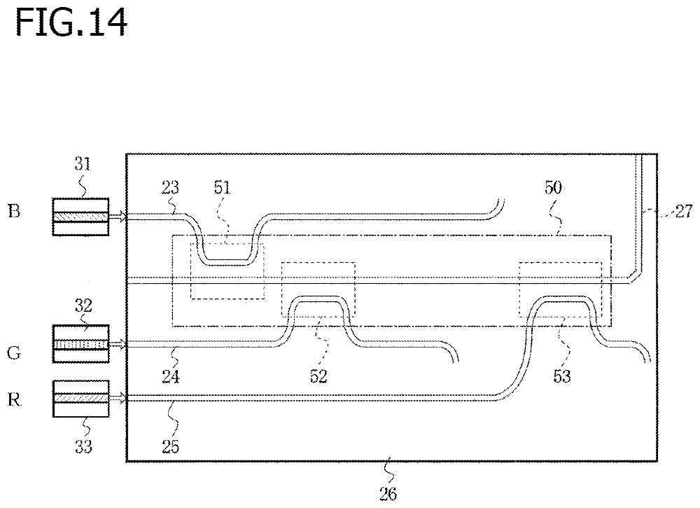

Next, the optical multiplexer in Example 7 of the present invention is described in reference to FIG. 14. The optical multiplexer in Example 7 is the same as that in Example 6 in terms of the basic configuration and the operation principles except that the output optical waveguide is bent on the emission end side in Example 7, unlike that in Example 6.

FIG. 14 is a plan diagram schematically illustrating the optical multiplexer in Example 7 of the present invention, and also illustrates a light source module by adding light sources to the optical multiplexer so that the invention can be easily understood. An optical multiplexing unit 50 forms an optical multiplexer together with input optical waveguides 23 through 25 and an output optical waveguide 27. Light radiated from a blue semiconductor laser chip 31, a green semiconductor laser chip 32 and a red semiconductor laser chip 33 is not directly coupled with the output optical waveguide 27, and the multiplexed light output moves entirely from the input optical waveguides 23 through 25 via optical coupling parts 51 through 53 in the configuration.

In Example 7 of the present invention, the output optical waveguide 27 is bent on the emission end side. Here, the bent angle is 90°; however, the bent angle may be any in the range from 85° to 95°, taking an error in manufacturing into consideration. In this case as well, a trench structure total reflection mirror as illustrated in FIG. 4 in Patent Literature 3 is used in order to bend the output optical waveguide 27 at a right angle; however, a bent waveguide with a small curvature radius may be used.

In this case as well, the structure illustrated in FIG. 14 can be adopted in the same manner as the structure illustrated in FIG. 11 so that the fan-shaped light beam that propagates through the clad can be prevented from mixing into the multiplexed output light beam optical path, and at the same time, light that has leaked out from any of the optical coupling parts 51 through 53 in the optical multiplexing unit 50 can be prevented from overlapping the multiplexed light emitted from the bent emission end in the output optical waveguide 27, which can further reduce the effects of noise light.

### Example 8

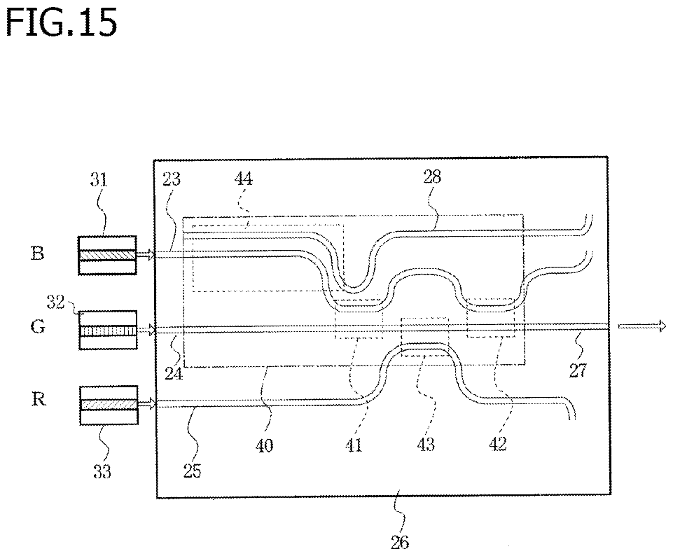

Next, the light source module in Example 8 of the invention is described in reference to FIG. 15. The light source module is exactly the same as that in FIG. 2A, which is described for the optical multiplexer with light sources being added. FIG. 15 is a schematic diagram illustrating the configuration of the optical multiplexer in Example 8 of the present invention. As illustrated in FIG. 15, a light beam from a blue semiconductor laser chip 31 is inputted into an input optical waveguide 23, a light beam from a green semiconductor laser chip 32 is inputted into an input optical waveguide 24, and a light beam from a red semiconductor laser chip 33 is inputted into an input optical waveguide 25. The input optical waveguides 23 through 25 are connected to the optical waveguide in the optical multiplexing unit 40 so that the multiplexed light that has been multiplexed in the optical multiplexing unit 40 can be outputted from the output end of the output optical waveguide 27.

The blue semiconductor laser chip 31, the green semiconductor laser chip 32 and the red semiconductor laser chip 33 are mounted in such a manner that the respective emission area matches the entrance areas of the input optical waveguides 23 through 25 in the lateral direction and in the height direction with each gap between the emission ends and the input optical waveguides 23 through 25 being 10 μm.

The structure of the optical multiplexing unit 40 is the same as that illustrated in FIG. 2A, where the size of the optical multiplexing unit 40 is 3 mm in length and 3.1 mm in width. The length of the optical coupling part 41 is 350 μm, the length of the optical coupling part 42 is 240 μm, the length of the optical coupling part 43 is 200 μm, and the length of the optical coupling part 44 is 1200 μm.

Here, the structure of the optical multiplexing unit in the light source module is not limited to that of the optical multiplexing unit 40, and the structure of the optical multiplexing unit 45 or 50 in Example 2 or 6 may be adopted. In addition, the arrangement of the light sources may be arbitrary, and the arrangement in Example 3 or 5 may be adopted. Furthermore, the output optical waveguide may be bent on the emission end side as that in Example 4 or 7.

### Example 9

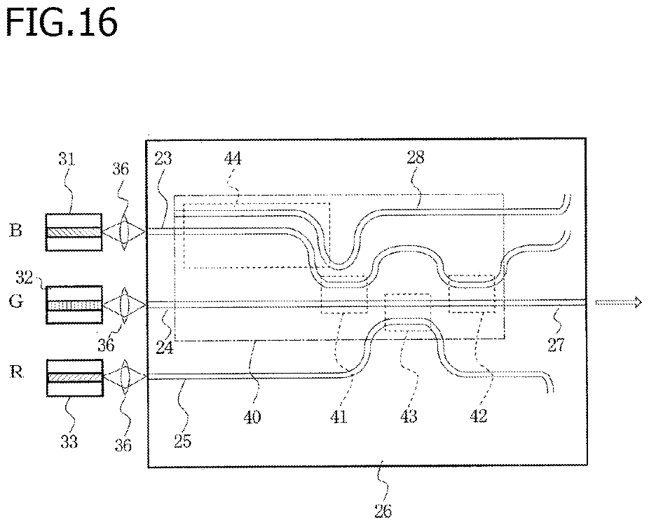

Next, the light source module in Example 9 in the present invention is described in reference to FIG. 16. The light source module in Example 9 is gained by providing lenses between the light sources and the input optical waveguides in the light source module in Example 8. FIG. 16 is a schematic diagram illustrating the configuration of the light source module in Example 9 of the present invention. As illustrated in FIG. 16, lenses 36 are provided vis-à-vis the blue semiconductor laser chip 31, the green semiconductor laser chip 32 and the red semiconductor laser chip 33.

In this case, microscopic sphere lenses having a focal distance of 0.54 mm and a sphere diameter of 1 mm are used as the lenses 36. Light beams that have been condensed by the microscopic sphere lenses are inputted into input optical waveguides 23 through 25. The condenser lenses are not limited to microscopic sphere lenses, and GRIN (gradient index type) lenses may be used.

In this case as well, the structure of the optical multiplexing unit in the light source module is not limited to that of the optical multiplexing unit 40, and the structure of the optical multiplexing unit 45 or 50 in Example 2 or 6 may be adopted. In addition, the arrangement of the light sources may be arbitrary, and the arrangement in Example 3 or 5 may be adopted. Furthermore, the output optical waveguide may be bent on the emission end side as that in Example 4 or 7.

### Example 10

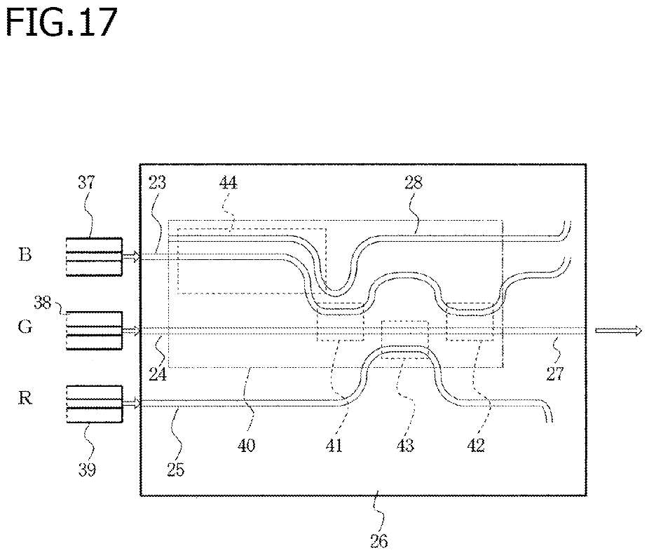

Next, the light source module in Example 10 of the present invention is described in reference to FIG. 17. The light source module in Example 10 is the same as that in Example 8 except that optical fiber emission ends are used as the light sources in the light source module in Example 10 instead of the semiconductor lasers in Example 8. The emission light wavelength of a red beam from the emission end of any of the optical fibers 37 through 39 is 640 nm, the emission light wavelength of a green beam is 530 nm, and the wavelength of a blue beam is 450 nm.

In this case as well, the structure of the optical multiplexing unit in the light source module is not limited to that of the optical multiplexing unit 40, and the structure of the optical multiplexing unit 45 or 50 in Example 2 or 6 may be adopted. In addition, the arrangement of the light sources may be arbitrary, and the arrangement in Example 3 or 5 may be adopted. Furthermore, the output optical waveguide may be bent on the emission end side as that in Example 4 or 7.

### Example 11

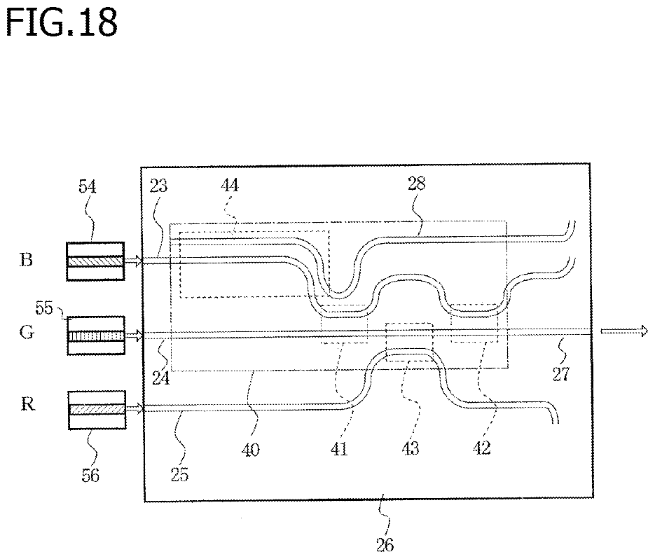

Next, the light source module in Example 11 of the present invention is described in reference to FIG. 18. The light source module in Example 11 is the same as that in Example 8 except that light emitting diodes (LEDs) are used as the light sources in the light source module in Example 11 instead of the semiconductor lasers in Example 8. That is to say, a blue LED chip 54 is used in place of the blue semiconductor laser chip 31, a green LED chip 55 is used in place of the green semiconductor laser chip 32, a red LED chip 56 is used in place of the red semiconductor laser chip 33, and the size of each component is slightly changed together with the above, and thus, the basic operation principles are the same with only a difference of whether or not the light beams are lasers. The emission light wavelength from the blue LED chip 54 is 450 nm, the emission light wavelength from the green LED chip 55 is 530 nm, and the emission light wavelength from the red LED chip 56 is 640 nm.

In this case as well, the structure of the optical multiplexing unit in the light source module is not limited to that of the optical multiplexing unit 40, and the structure of the optical multiplexing unit 45 or 50 in Example 2 or 6 may be adopted. In addition, the arrangement of the light sources may be arbitrary, and the arrangement in Example 3 or 5 may be adopted. Furthermore, the output optical waveguide may be bent on the emission end side as that in Example 4 or 7, or lenses may be interposed as that in Example 9.

### Example 12

Next, the two-dimensional optical scanning device in Example 12 of the present invention is described. The basic structure of the two-dimensional optical scanning device in Example 12 is the same as that illustrated in FIG. 20 with only a difference in the structure of the optical multiplexer, and therefore, FIG. 20 is used for the description. The two-dimensional optical scanning device in Example 12 of the present invention is gained by replacing the optical multiplexer 62 in the two-dimensional optical scanning device in FIG. 20 with the above-described optical multiplexer in Example 1. This optical multiplexer may be replaced with the optical multiplexer in FIG. 2 or 6. In addition, the arrangement of the light sources may be replaced with the arrangement in any of Examples 1 through 7. Furthermore, lenses may be provided or the light sources may be replaced with optical fibers or LEDs as illustrated in any of FIGS. 16 through 18.

### Example 13

Next, the image formation device in Example 13 of the present invention is described. The basic structure of the image formation device in Example 13 is the same as that illustrated in FIG. 21 except for only a difference in the structure of the optical multiplexer, and therefore, FIG. 21 is used for the description. The image formation device in Example 13 of the present invention is gained by replacing the optical multiplexer 62 in the image formation device illustrated in FIG. 21 with the above-described optical multiplexer in Example 1. This optical multiplexer may be replaced with that in Example 2 or 7. In addition, the arrangement of the light sources may be replaced with the arrangement in any of Examples 1 through 7. Furthermore, lenses may be provided or the light sources may be replaced with optical fibers or LEDs as illustrated in any of FIGS. 16 through 18.

In this image formation device, in the same manner as in the prior art, a control unit 70 has a sub-control unit 71, an operation unit 72, an external interface (I/F) 73, an R laser driver 74, a G laser driver 75, a B laser driver 76 and a two-dimensional scanning driver 77. The sub-control unit 71 is formed of a microcomputer that includes a CPU, a ROM, a RAM and the like. The sub-control unit 71 generates an R signal, a G signal, a B signal, a horizontal signal and a vertical signal that become elements for synthesizing an image on the basis of the image data supplied from an external apparatus such as a PC via the external I/F 73. The sub-control unit 71 transmits the R signal to the R laser driver 74, the G signal to the G laser driver 75, and the B signal to the B laser driver 76, respectively. In addition, the sub-control unit 71 transmits the horizontal signal and the vertical signal to the two-dimensional scanning driver 77, and controls the current to be applied to the electromagnetic coil 64 so as to control the operation of the movable mirror unit 63.

The R laser driver 74 drives the red semiconductor laser chip 33 so that a red laser beam of which the optical quantity corresponds to the R signal from the sub-control unit 71 is generated. The G laser driver 75 drives the green semiconductor laser chip 32 so that a green laser beam of which the optical quantity corresponds to the G signal from the sub-control unit 71. The B laser driver 76 drives the blue semiconductor laser chip 31 so that a blue laser beam of which the optical quantity corresponds to the B signal from the sub-control unit 71 is generated. It becomes possible to synthesize a laser beam having a desired color by adjusting the intensity ratio between the laser beams of the respective colors.

The respective laser beams generated in the blue semiconductor laser chip 31, the green semiconductor laser chip 32 and the red semiconductor laser chip 33 are multiplexed in the optical multiplexing unit (40) in the optical multiplexer, and after that reflected from the movable mirror unit 63 for two-dimensional scanning. An image is formed on a retina 80 as a result of scanning with the multiplexed laser beam that has been reflected from a concave reflection mirror 78 and passed through a pupil 79.

### REFERENCE SIGNS LIST

1 substrate
2 output optical waveguide
3 optical multiplexing unit
4 first input optical waveguide
5 second input optical waveguide
6 third input optical waveguide
7₁, 7₂ first optical coupling part
8 second optical coupling part
9 optical waveguide for discarding light
10 third optical coupling part
11₁, 11₂, 11₃ light source
12 bent portion
21 Si substrate
22 lower clad layer
23 through 25 input optical waveguide
26 upper clad layer
27 output optical waveguide
28 optical waveguide for discarding light
31 blue semiconductor laser chip
32 green semiconductor laser chip
33 red semiconductor laser chip
36 lens
37 through 39 optical fiber
40, 45, 50 optical multiplexing unit
41 through 44, 46 through 48, 51 through 53 optical coupling part
54 blue LED chip
55 green LED chip
56 red LED chip
61 substrate
62 optical multiplexer
63 movable mirror unit
64 electromagnetic coil
70 control unit
71 sub-control unit
72 operation unit
73 external interface (I/F)
74 R laser driver
75 G laser driver
76 B laser driver
77 two-dimensional scanning driver
78 concave reflection mirror
79 pupil
80 retina

1. An optical multiplexer, comprising:
a plurality of input optical waveguides that include at least a first input optical waveguide and a second input optical waveguide; and
an output optical waveguide that has an optical multiplexing unit and at least a portion of which is an optical waveguide in linear form, wherein the first input optical waveguide has a first optical coupling part that optically couples with the output optical waveguide in the optical multiplexing unit,
the second input optical waveguide has a second optical coupling part that optically couples with the output optical waveguide in the optical multiplexing unit,
the first optical coupling part is set in such a manner that the attenuation of a light beam that has been inputted into the first input optical waveguide relative to the light beam that has been outputted from the output optical waveguide is in a range from 5 dB to 40 dB, and
the second optical coupling part is set in such a manner that he attenuation of a light beam that has been inputted into the second input optical waveguide relative to the light beam that has been outputted from the output optical waveguide is in a range from 5 dB to 40 dB.

2. The optical multiplexer according to claim 1, wherein the output optical waveguide is an optical waveguide in linear form in at least the region except the proximity to the emission end.

3. The optical multiplexer according to claim 2, wherein the output optical waveguide is inclined at an angle of 85 degrees to 95 degrees relative to the optical waveguide in linear form in proximity to the emission end.

4. The optical multiplexer according to claim 1, wherein
the plurality of input optical waveguides includes a third input optical waveguide,
the third input optical waveguide also works as an optical waveguide on the emission end side in the output optical waveguide,
the first input optical waveguide has a third optical coupling part for wave dividing the optical beam that has entered into the first input optical waveguide in a stage before the optical coupling with the optical multiplexing unit.

5. The optical multiplexer according to claim 4, wherein the first optical coupling part is separated into two optical coupling parts with the second optical coupling part in-between.

6. The optical multiplexer according to claim 1, wherein
the plurality of input optical waveguides includes a third input optical waveguide, and
the third input optical waveguide has a third optical coupling part that optically couples with the second input optical waveguide in a stage before the second optical coupling part.

7. The optical multiplexer according to claim 1, wherein
the plurality of input optical waveguides includes a third input optical waveguide, and
the third input optical waveguide has a third optical coupling part that optically couples with the output optical waveguide in the optical multiplexing unit.

8. The optical multiplexer according to claim 4, wherein the optical multiplexing unit multiplexes at least the light of three primary colors, red light, blue light and green light.

9. The optical multiplexer according to claim 1, wherein the waveguide direction in proximity to the input ends of the plurality of input optical waveguides is inclined at an angle of 85 degrees to 95 degrees relative to the optical waveguide in linear form.

10. The optical multiplexer according to claim 1, wherein the first waveguide direction in proximity to the input end of at least one input optical waveguide from among the plurality of input optical waveguides is inclined at an angle of 85 degrees to 95 degrees relative to the optical waveguide in linear form, and the second waveguide direction in proximity to the input ends of the remaining input optical waveguides from among the plurality of input optical waveguides is inclined at an angle of 85 degrees to 95 degrees relative to the optical waveguide in linear form so as to be opposed to the first waveguide direction.

11. A light source module, comprising:
the optical multiplexer according to claim 1; and
a plurality of light sources for entering light beams into the optical multiplexer.

12. The light source module according to claim 11, wherein lenses are provided between the plurality of light sources and a plurality of input optical waveguides of the optical multiplexer.

13. The light source module according to claim 11, wherein the plurality of light sources are a blue semiconductor laser, a green semiconductor laser and a red semiconductor laser.

14. The light source module according to claim 11, wherein the plurality of light sources are a blue light emitting diode, a green light emitting diode and a red light emitting diode.

15. The light source module according to claim 11, wherein the plurality of light sources are light emissions from a plurality of optical fibers.

16. A two-dimensional optical scanning device, comprising:
the light source module according to claim 11; and
a two-dimensional optical scanning mirror device for two-dimensional scanning with multiplexed light from the light source module.

17. An image projection device, comprising:
a two-dimensional optical scanning device according to claim 16; and
an image formation unit for projecting onto a projection plane an image scanned with multiplexed light by means of the two-dimensional optical scanning mirror device.
